(19) United States
(12) Patent Application Publication
(10) Pub. No.: US 2014/0051303 A1
(43) Pub. Date: Feb. 20, 2014

(54) ELECTRICAL CONNECTOR

(71) Applicant: Hon Hai Precision Industry Co., Ltd., New Taipei (TW)

(72) Inventors: CHUN-MING YU, Kunshan (CN); JI-CHAO WANG, Kunshan (CN); GUO-HUA ZHANG, Kunshan (CN); QI-SHENG ZHENG, Kunshan (CN)

(73) Assignee: HON HAI PRECISION INDUSTRY CO., LTD., New Taipei (TW)

(21) Appl. No.: 13/966,308

(22) Filed: Aug. 14, 2013

(30) Foreign Application Priority Data
Aug. 14, 2012 (CN) 201220400590.3

(51) Int. Cl. H01R 13/46

(52) U.S. Cl. CPC H01R 13/46
USPC 439/660

(57) ABSTRACT

An electrical connector comprises an insulative housing with a base portion and a tongue portion extending forwardly form the base portion, a plurality of contacts retained in the insulative housing and a shell surrounding the tongue portion to form a mating port. The shell has two side walls located at two sides of the mating port, and at least one side walls forming a detecting pad. A detecting contact is retained in the insulative housing and aligned with the detecting pad, and the detecting contact has a detecting arm extending forwardly. The side wall further has a bridge behind the detecting pad, the bridge and the detecting pad both protrude beyond the side wall to form a room therebetween, the room is beside the mating port and communicates with the mating port, and the detecting arm is received in the room and partly protrudes into the mating port.

### BACKGROUND OF THE INVENTION

1. Field of the Invention

The present invention relates to an electrical connector, more particularly to an electrical connector with detecting terminals for detecting different plugs inserted therein.

2. Description of Related Art

China patent issue No. CN202231226U, issued on May, 23, 2012, discloses a conventional electrical connector including an insulative housing, a plurality of contacts retained in the insulative housing, a shell attached to the insulative housing, an insulative arm insert-molding on a side of the insulative housing and a detecting contact retained in the insulative arm. The insulative housing has a tongue portion. The shell surrounds the tongue portion to form a mating cavity. The shell has two side walls. One of the side walls has a detecting arm tore from the side wall. The detecting arm has a resilient arm extending forwardly and an engaging portion at a free end of the resilient arm. The detecting contact retained in the insulative arm, has a contacting portion cantilevered outside of the side wall of the shell. To form such structure, more materials is needed to make the electrical connector and the detecting contact located outside of the side wall makes a much more big size of the electrical connector.

Hence, an improved electrical connector with improved structure is needed to solve the problem above.

### BRIEF SUMMARY OF THE INVENTION

An electrical connector comprises an insulative housing having a base portion and a tongue portion extending forwardly form the base portion. A plurality of contacts are retained in the insulative housing; A shell surrounds the tongue portion to form a mating port and has two side walls located at two sides of the mating port, at least one of the side walls forming a detecting pad. A detecting contact is retained in the insulative housing and located corresponding to the detecting pad, each of the detecting contact has a detecting arm extending forwardly. wherein the side wall further has a bridge behind the detecting pad, the bridge and the detecting pad both protrude beyond the side wall to form a room therebetween, and the room is located beside the mating port and communicates with the mating port, the detecting arm is received in the room and partly protrudes into the mating port.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector according to the present invention;

FIG. 2 is a partially exploded, perspective view of the electrical connector;

FIG. 3 is a similar view to FIG. 2, but taken from another aspect;

FIG. 4 is a view of the electrical connector with its shell removed and two detecting terminals separated from an insulactive housing;

FIG. 5 is an exploded, perspective view of the electrical connector;

FIG. 6 is a similar view to FIG. 5, but taken from another aspect;

FIG. 7 is a cross-sectional view of the electrical connector taken along line 7-7 of FIG. 1;

FIG. 8 is a similar view to FIG. 7 to show a state when an USB PD (Power Deliver) plug is inserted into;

FIG. 9 is a similar view to FIG. 8 but show a Standard USB plug is inserted into.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

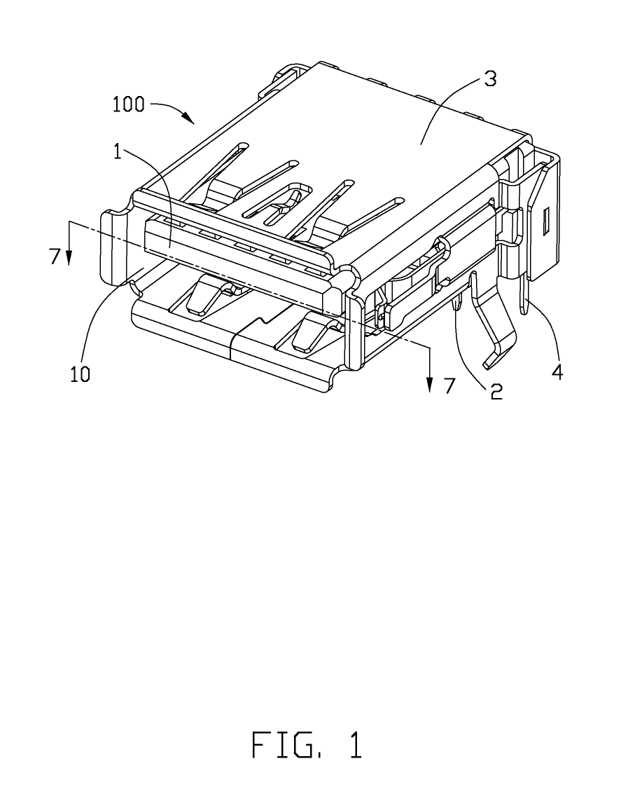

Please referring to FIGS. 1-9, an electrical connector 100 with a mating port same as the standard USB 3.0 receptacle, can mate with a standard USB 3.0 plug or a USB Power Delivery plug which can deliver a big power beyond 2A. The electrical connector 100 can detect said two plugs respectively as their insertion into thereof The electrical connector 100 includes an insulative housing 1, a plurality of contacts 2 retained in the insulative housing 1, a shell 3 enclosing the insulative housing 1 and a plurality of detecting contacts 4 assembled to the insulative housing 1.

Please reference to FIGS. 1-6, the insulative housing 1 includes a base portion 11, a tongue portion 12 assembled to the base portion 11 along a front-to-back direction and a spacer 13 retained in a back side of the base portion 11. The base portion 11, the tongue portion 12 and the shell 3 form a mating port 10 together. The base portion 11 includes a main body 110 and a supporting plate 111 extending forwardly from a bottom side of the main body 110. The main body 110 has a front face 112, a rear face 113 opposite to the front face 112, a first receiving slot 114 partly extending backwardly through the main body 110 from the front face 112 in a transverse direction, two second receiving slots 115 extending downwardly and laterally from two sides of the first receiving slot 114 and communicating with the first receiving slot 114, two side portions 116 located outside of the two second receiving slots 115, respectively, and a top portion 117 located above the first receiving slot 114. The base portion 11 further defines a plurality of first retaining slots 118 extending through the main body 110 and communicating with the first receiving slot 114 and a plurality of second retaining slots 119 sandwich between the two second receiving slots 115.

The side portions 116 extend beyond the rear face 113 and a receiving cavity 1130 is formed therebetween. An inner wall of the side portion 116 has a block 1161, a locking slot 1162 depressing thereon and communicating with the second receiving slot 115, and a protrusion 1163 protruding into the receiving cavity 1130. The base portion 11 further has two addition portions 1164 located outside of the two side portions 116 respectively for retaining the detecting contacts 4. Two T-shaped slots (not labeled) formed between the two side portions 116 and the two addition portions 1164 for positing the detecting contacts 4, and each of the T shaped slots includes a first slot 1165 extending transversely and a second slot 1166 extending vertically and communicating with the first slot 1165.

The tongue portion 12 has a plate 121 and a retaining portion 122 retained in the second receiving slot 115. A rear end of the plate 121 is received in the first receiving slot 114. The tongue portion 12 has a top surface 123, a bottom surface 124 opposite to the top surface 123, a mating face 125 located in a front end of the plate 121 and two side surfaces 126. The plate 121 has a plurality of first receiving grooves 127 extending in a front-to-back direction and a plurality of second receiving grooves 128 located in front of the first receiving grooves 127. The retaining portion 122 has a pair of locking arms 1221 extending from a rear end thereof to lock with the locking slot 1162 and two locking portions 1222 set at a free end of the locking arms 1221 respectively.

The plate 121 further comprises a first notch 1261 depressing from one side surface 126 and a second notch 1262 depressing from another side surface 126. The first notch 1261 is closed to the front face 112 of the base portion 11 while the second notch 1262 is closed to the mating face 15 of the plate 121.

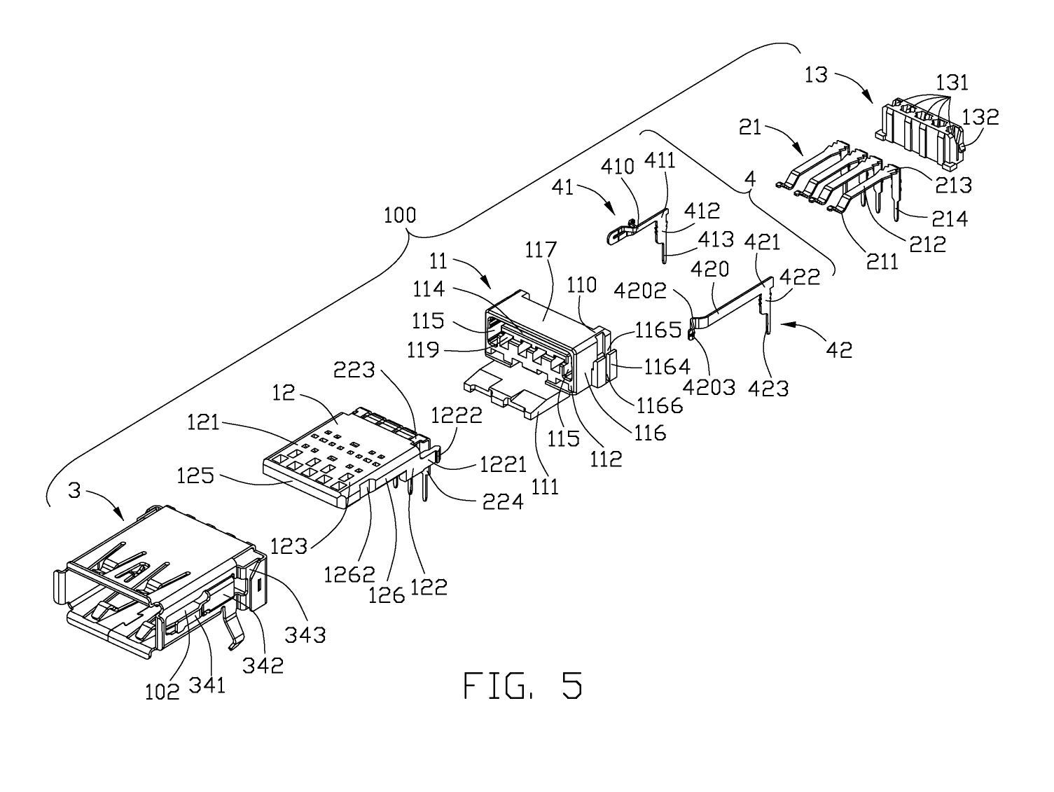

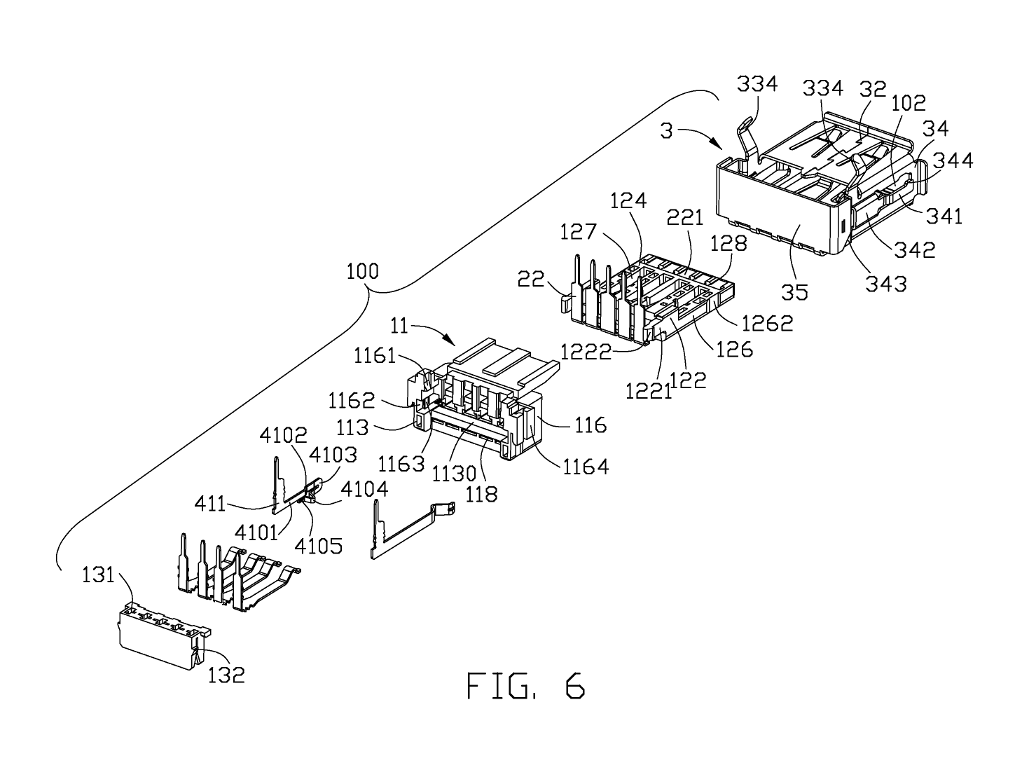

Please reference to FIGS. 5-6, the contacts 2 include a plurality of first contacts 21 and a plurality of second contacts 22 positioned in the insulative housing 1. Each of the first contacts 21 has a first connecting portion 212 received in the first receiving groove 127, a first contacting portion 211 resiliently extending into the mating port 10, a first positioning portion 213 retained in the second retaining slot 119 and a first soldering portion 214 extending vertically from the first positioning portion 213.

The second contacts 22 are inserting-molded in the tongue portion 12. Each of the second contacts 22 includes a second positioning portion (not labeled) inserting-molded in the tongue portion 12, a second contacting portion 221 shaped as a flat piece extending from a front end of the second positioning portion and received in the second receiving groove 128, a second posting portion 223 extending backwardly from another end of the second posting portion 223 to be received in the first retaining slot 118 and a second soldering portion 224 extending vertically from the second positioning portion 223. The first contacting portions 211 and the second contacting portions 221 are arranged in two lines respectively along a front-to-back direction.

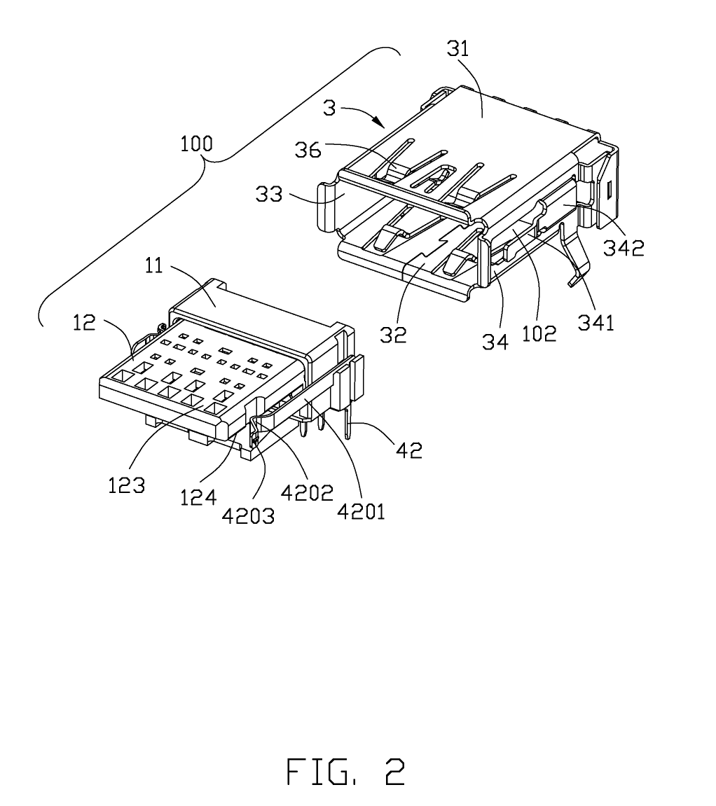

Please refer to FIGS. 2-3 and 5-6, the detecting contacts 4 include a first detecting terminal 41 retained in the T shaped slot of the base portion 11 and a second detecting terminal 42 retained in another T shaped slot of the base portion 11. The first detecting terminal 41 is used for detecting whether an USB PD plug for transmitting a big power of 2A is inserted into, while the second detecting terminal 42 is used for detecting whether a standard USB plug is inserted into. Refer to FIG. 5, the first detecting terminal 41 has a first retaining portion 412 vertically received in the second slot 1166 at one side of the side portion 116, a first horizontal portion 411 retained in the first slot 1165, a first soldering leg 413 extending from the first retaining portion 412 and beyond the second slot 1166, and a first detecting arm 410 extending into the mating port 10 from the first horizontal portion 411. The second detecting terminal 42 has a second retaining portion 422 vertically received in the second slot 1166 at another side of the other side portion 116, a second horizontal portion 421 retained in the first slot 1165, a second soldering leg 423 extending from the second retaining portion 422 and beyond the second slot 1166, and a second detecting arm 420 extending into the mating port 10 from the second horizontal portion 421.

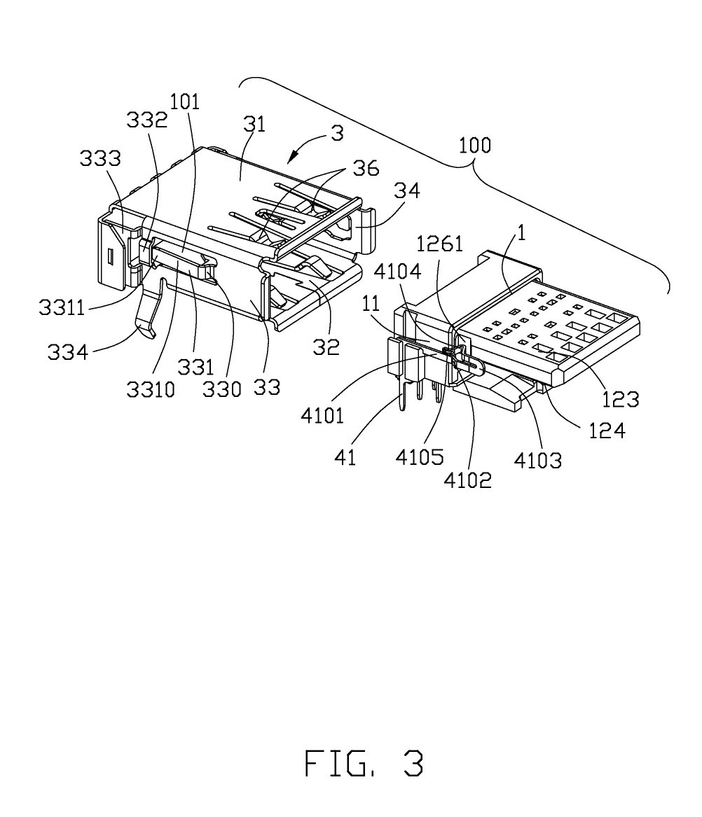

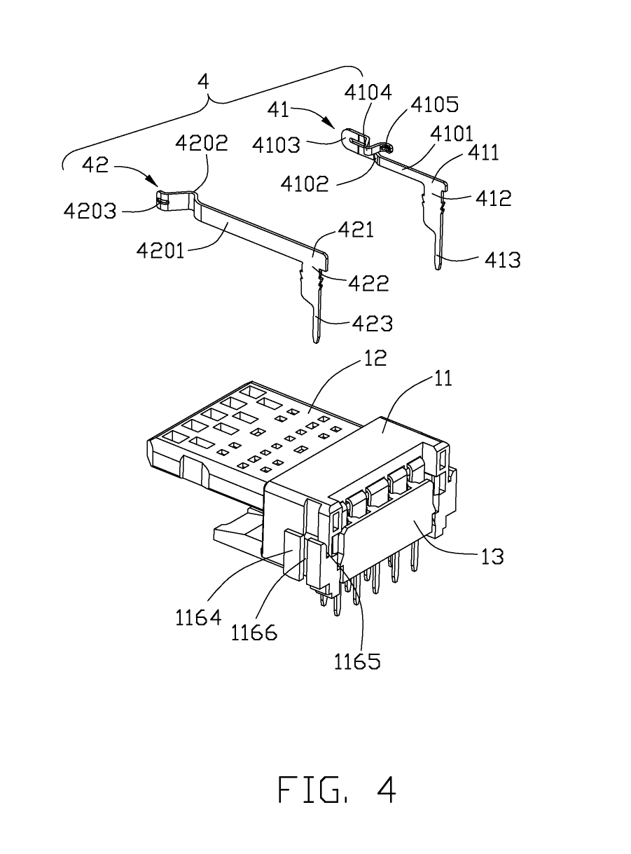

Please refer to FIG. 4, the first detecting arm 410 includes a first extending portion 4101 forwardly extending from the horizontal portion 411, an inclined portion 4102 forwardly and outwardly extending from the first extending portion 4101, a first engaging portion 4104 protruding into the mating port 10, an U-shaped connecting part 4103 disposed at a front end thereof and connecting with the first engaging portion 4104 and the inclined portion 4102 upon the first engaging portion 4104, and a first end portion 4105 extending backwardly from the first engaging portion 4104 and located at a free end thereof The detecting arm 410 has the first extending portion 4101, the inclined portion 4102, the connecting part 4103, the first engaging portion 4104 and the first end portion 4105, in this arrangement, the structure can enhance the resilience of the first detecting arm 410. Please refer to FIGS. 3-7, the first detecting arm 410 is set vertically, the first extending portion 4101 is located outside of the base portion 11, the connecting part 4103 is located outside of the first extending portion 4101, the first engaging portion 4104 inwardly protrudes to engage with an inner wall of the first notch 1261 in a left side of the tongue portion 12.

The second detecting arm 42 includes a second extending portion 4201 extending forwardly from the second horizontal portion 421 located outside of the mating port 10, a second engaging portion 4202 extending forwardly from the second horizontal portion 421 and protruding into the mating port 10, and a second end portion 4203 at a free end thereof The second extending portion 4201 engages with an inner wall of the second notch 1260 at right side of the tongue portion 12. The second extending portion 4201 is closer to the mating face 125 than the first extending portion 4101. Please reference to FIGS. 2-3, a bottom edge of the second engaging portion 4202 extends beyond the bottom surface 124 of the tongue portion 12, the first engaging portion 4104 and the first end portion 4105 are located between the top surface 123 and the bottom surface 124. Please refer to FIGS. 4-6, the spacer 13 is assembled to the receiving cavity 1130 of the base portion 11 along a down-to-upper direction. The spacer 13 defines a plurality of passageways 131 for receiving the second soldering legs 224 and two islands 132 protruding outside from two side of the spacer 11 and abutting against with the block 1161 to positioning the spacer 13 to the insulative housing 1.

Please refer to FIGS. 3, 5 and 6, the shell 3 has a top wall 31 located over the mating port 10, a bottom wall 32 opposite to the top wall 31, a first side wall 33 located at a left side of the tongue portion 12, a second side wall 34 located at a right side of the tongue portion 12 and a rear wall 35 bending downwardly from a rear end of the top wall 31. The first side wall 33 has a first detecting pad or tang 331 tore from the first side wall 33 and extending beyond a plane of the first side wall located therein, a first room 101 is formed between the first detecting pad 331 and the first side wall 33 for receiving the first detecting contact 41. The second side wall 34 has a second detecting pad 341 tore from the second side wall 34 and extending beyond a plane of the second side wall located therein, a second room 102 is formed between the second detecting pad 341 and the second side wall 34 for receiving the second detecting contact 42.

The first side wall 33 further has a bridge 332 protruding outwardly, a first additional wall 333 extending from an end of the first side wall 33 and located outside of the first side wall 33 for covering the additional portion 1164 of the base portion 11, and a retaining leg 334 extending downwardly from a bottom edge of the first side wall 33. The first additional wall 333 is located behind the bridge 332. A top edge and a bottom edge of the bridge 332 connects with the first side wall, and a front edge and a rear edge of the bridge 332 is separated from the first side wall 33, by this arrangement, the bridge 332 can enhance the strength of the first side wall 33. The first detecting pad 331 has a bending part 330 slant outwardly of the first side wall 33, a first extending arm 3310 extending forwardly from the bending part 330 and a first contacting point 3311 located at a free end of the first extending arm 3310. The first contacting point 3311 is separated with the bridge 332 and would engage with the first engaging portion 4104 as a plug is inserted into the electrical connector 100. An outside surface of the first extending arm 3310 is coplanar with an outside surface of the bridge 332. Partly of the second side wall 34 at a rear end protrudes outside of the second side wall 34 to form an emboss 342, and the second detecting pad 341 extends forwardly from a front middle of the emboss 342, the second side wall 34 further has a second additional wall 343 covering over the additional portion 1164 of the right side portion 116. The second detecting pad 341 has a second contacting point 344 located at a free end thereof The second contacting point 344 would engage with the second end portion 4203 of the second detecting terminal 42. The top wall 31 and the bottom wall 32 have a plurality of fingers 36 for positioning the plug.

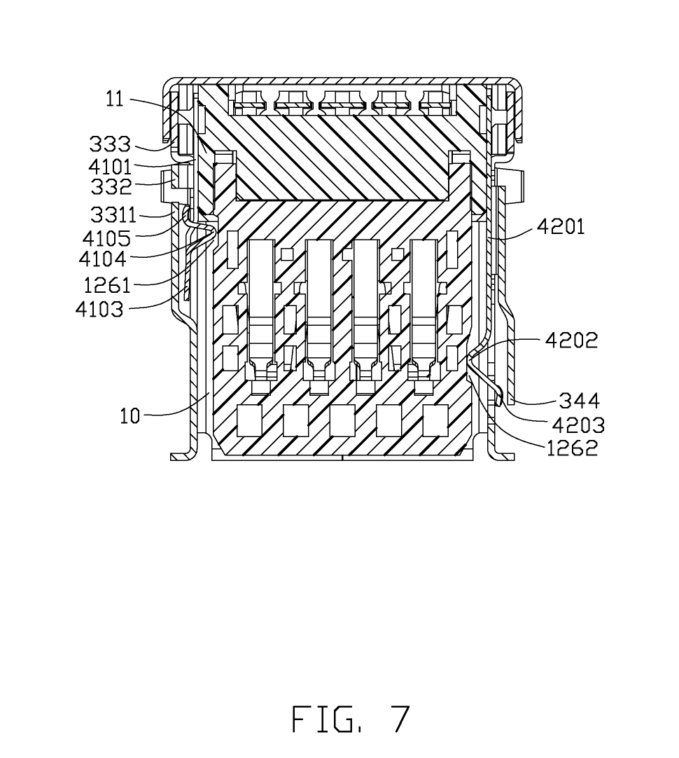

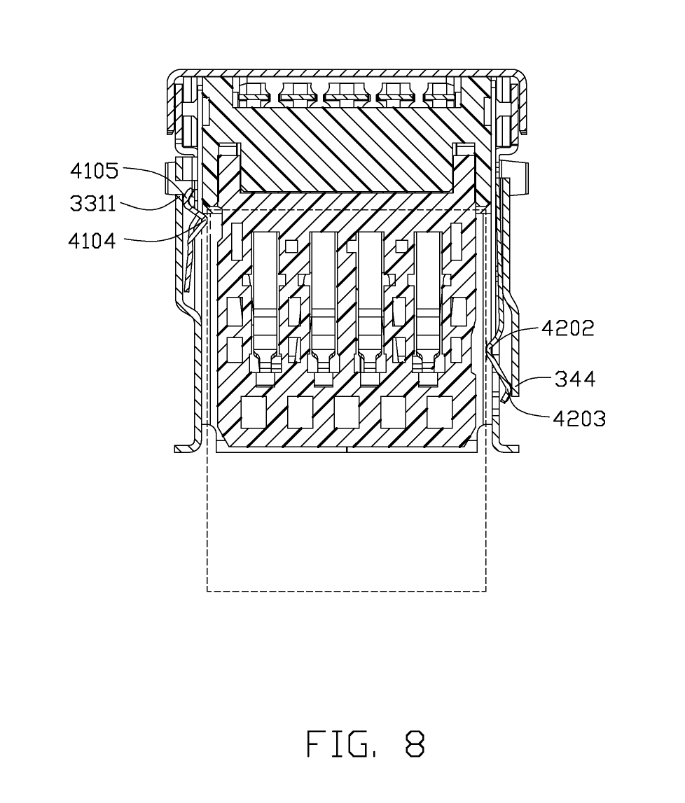

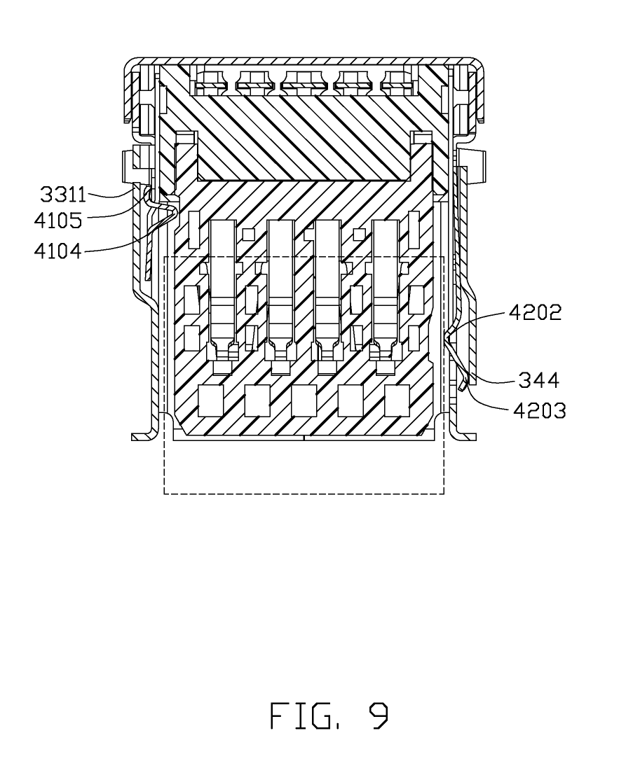

Please refer to FIGS. 7-9, FIG. 7 and FIG. 9 show different plugs are inserted into the electrical connector 100. As shown in FIG. 7, in original state, the first and second end portion 4105, 4203 are separated from the shell 3. As shown in FIG. 8, when an USB PD plug with a longer mating body is inserted into the electrical connector 100, the mating body of the plug presses the first and second detecting terminals 41, 42 respectively, then the first engaging portion 4104 and the second engaging portion 4202 move outside and make the first and second end portions 4105, 4203 connect with the first and second contacting points 3311, 344 respectively. As an Thin Card (not shown) is inserted into the electrical connector 100, although the Thin card has a longer body and can reach the back end of the mating port 10, but, the Thin Card has a thin body which just needs a bottom side part of the mating port under the tongue portion 12, the first engaging portion 4104 of the first detecting terminal 41 does not extend beyond the bottom surface 124 of the tongue portion 12, so the Thin Card just can engage with the second engaging portion 4202 of the second detecting terminal 42 and make the second end portion 4203 move outside and connect with the second contacting point 344. As shown in FIG. 9, when the standard USB plug is inserted into the electrical connector 100, for the standard USB has a shorter mating body that can not reach the end of the mating port 10, so the USB plug can not engage with the first detecting terminal 41 and just can engage with the second engaging portion 4202 of the second detecting terminal 42, the second end portion 4203 would move outside and touch with the second contacting point 344.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical connector comprising:
an insulative housing having a base portion and a tongue portion extending forwardly the base portion;
a plurality of contacts retained in the insulative housing;
a shell surrounding the tongue portion to form a mating port, and having two side walls located at two sides of the mating port, at least one of the side walls formed with a detecting pad; and
at least one detecting contact retained in the insulative housing and located corresponding to the detecting pad, the detecting contact having a detecting arm extending forwardly; wherein
the side wall further has a bridge behind the detecting pad, the bridge and the detecting pad are both located outside of the side wall along a left-to-right direction to form a room together, the room is located beside the mating port and communicate with the mating port, the detecting arm is received in the room and partly protruding into the mating port.

2. The electrical connector as claimed in claim 1, wherein a top and a bottom edges of the bridge connect with the side wall, while a front and a rear edges of the bridge do not connect with the side wall.

3. The electrical connector as claimed in claim 2, wherein the detecting pad comprises an extending arm extending from the side wall along a front-to-back direction and a contacting point located at a free end of the extending arm, the contacting point is separated with the bridge, an outside surface of the extending arm and an outside surface of the bridge are in coplanar.

4. The electrical connector as claimed in claim 1, wherein the insulative housing has an addition portion insert-molded with the base portion as one unit and located at a side of the base portion, the shell has an additional wall covering the addition portion, the additional wall is located outside of the side wall.

5. The electrical connector as claimed in claim 4, wherein the detecting contact has a retaining portion fixed in the addition portion, the detecting arm extending forwardly from the retaining portion and received in the room.

6. The electrical connector as claimed in claim 5, wherein the detecting arm includes a first extending portion extending forwardly, an inclined portion extending outwardly from the extending portion, an U-shaped connecting part with one end thereof connecting with the inclined portion, a first engaging portion connecting with the other end of the engaging portion and a first end portion located in a free end of the first engaging portion.

7. The electrical connector as claimed in claim 6, wherein the first engaging portion of the detecting arm protrudes into the mating port, and is received in a first notch depressed from a side surface of the tongue portion.

8. The electrical connector as claimed in claim 6, wherein the tongue portion has a top surface and a bottom surface opposite to the top surface, the first engaging portion is located between the top and bottom surfaces along a vertical direction.

9. The electrical connector as claimed in claim 1, wherein the detecting contact comprises a first detecting terminal located at a same side with the bridge and a second detecting terminal located at the other side of the shell, a free end of the second detecting terminal is closer to a mating face of the tongue portion than that of the first detecting terminal.

10. The electrical connector as claimed in claim 9, wherein a side wall of the shell corresponding to the second detecting terminal comprises an emboss protruding outwardly from the side wall, the detecting pad extends forwardly from the emboss and is located outside of the side wall, another room is defined by the detecting pad and the side wall, the second detecting terminal defines a second extending portion, a second engaging portion extending forwardly from the second extending portion and protruding into the mating port partly, and a second end portion at a free end of the second engaging portion.

11. An electrical connector comprising:
an insulative housing having a base portion and a tongue portion extending forwardly form the base portion;
a plurality of contacts retained in the insulative housing;
a shell surrounding the tongue portion and having two side walls located at two sides of the tongue portion, one side wall formed with a first detecting pad extending backwardly along a front-to-back direction and the other side wall formed with a second detecting pad extending forwardly along a back-to-front direction; and
two detecting contacts retained in two sides of the insulative housing and located corresponding to the detecting pads respectively, each of the detecting contact having a detecting arm extending forwardly and located inside of the detecting pad; wherein
the side wall further has a bridge at a rear end thereof, the bridge is coplanar with the detecting pad and is located outside of the side wall.

12. The electrical connector as claimed in claim 11, wherein the tongue portion has a top surface and a bottom surface opposite to the top surface, two side surfaces connecting with the top and bottom surfaces along a top-to-bottom direction and a mating face at a free end thereof, the tongue portion further comprises two notches depressing from two side surfaces thereof, one is closed to the mating face of the tongue and the other is closed to a front face of the base portion.

13. An electrical connector comprising:
an insulative housing defining a base portion with a mating tongue forwardly extending therefrom in a front-to-back direction, wherein a dimension of the mating tongue is smaller than that of the base portion in the transverse direction perpendicular to said front-to-back direction;
an additional side portion of the base portion protruding outwardly from a side portion of the base portion in said transverse direction;
a plurality of contacts disposed in the housing with contacting sections exposed upon the mating tongue;
a detecting contact attached to the corresponding additional side portion; and
a metallic shell securely enclosing said housing and including opposite top and bottom walls in a vertical direction perpendicular to both said front-to-back direction and said transverse direction, and two opposite side walls in the transverse direction wherein all said top wall, said bottom wall, and said two opposite sides walls commonly define a receiving cavity into which said detecting contact and said mating tongue with the contacting sections extend;
the two opposite side walls being seated upon corresponding side portions of the base portion, one of said side walls further including an additional side wall attached upon the additional side portion; wherein
viewed in the vertical direction, a step structure is formed on said additional side wall in comparison with the corresponding side wall.

14. The electrical connector as claimed in claim 13, wherein the corresponding side wall defines a bulged bridge around a boundary with said additional side wall to form a room in which said detecting contact is received with transverse deflection freedom thereof.

15. The electrical connector as claimed in claim 14, wherein said housing and said shell are configured to allow said shell to be rearwardly assembled to the housing only along said front-to-back direction.

16. The electrical connector as claimed in claim 15, wherein corresponding side wall defines a deflectable detecting tang outside of the detecting contact and adapted to be contacted by said detecting contact when the detecting contact is transversely deflected by an inserted plug.

17. The electrical connector as claimed in claim 16, wherein said detecting tang unitarily extends from the bridge along said front-to-back direction.

18. The electrical connector as claimed in claim 16, wherein said detecting tang provides another room in the transverse direction to allow outwardly transverse deflection of the detecting contact during mating.

19. The electrical connector as claimed in claim 14, wherein said additional side wall defines a cutout to allow the detecting contact to extend therethrough.

20. The electrical connector as claimed in claim 14, wherein the additional side portion and the detecting contact are configured to allow said detecting contact to be downwardly assembled to the additional side portion in the vertical direction.
